(19) United States
(12) Patent Application Publication
(10) Pub. No.: US 2019/0101848 A1
(43) Pub. Date: Apr. 4, 2019

(54) IMAGE FORMING APPARATUS

(71) Applicant: CANON KABUSHIKI KAISHA, Tokyo (JP)

(72) Inventor: Shunsuke Hijikata, Yokohama-shi (JP)

(21) Appl. No.: 16/135,978

(22) Filed: Sep. 19, 2018

(30) Foreign Application Priority Data
Oct. 3, 2017 (JP) 2017-193781

(51) Int. Cl. G03G 15/08; G03G 21/18; G03G 21/16

(52) U.S. Cl. CPC G03G 15/0865; G03G 2215/0692; G03G 21/1647; G03G 21/1842

(57) ABSTRACT

An image forming apparatus including a first unit having an image bearing member, a second unit having a development member, an apparatus main body which includes an opening portion, an opening-closing member to open or close the opening portion, a first portion contacting with a part of the first unit to position the first unit to the apparatus main body, and a second portion arranged on an opposite side of the first portion with respect to the image bearing member, and a sandwiched unit movable between a first position at which the sandwiched unit is sandwiched between the first unit and the second portion and a second position at which the sandwiched unit is not sandwiched, wherein when the sandwiched unit is located at the first position, a part of the first unit is urged against the first portion by the sandwiched unit.

### BACKGROUND OF THE INVENTION

### Field of the Invention

The present invention relates to an image forming apparatus which forms an image on a recording medium and discharges the recording medium. In particular, the present invention relates to an image forming apparatus in which a cartridge consisting of components necessary to be replaced according to use of the apparatus is detachably attached to an apparatus main body and the cartridge.

### Description of the Related Art

The above-described image forming apparatus includes an opening-closing cover which a user rotationally moves to expose an inner portion of the apparatus main body to attach or detach the cartridge. There is provided an opening-closing cover having a cartridge push-in unit which enables the cartridge to be pushed into an image forming position through a closing operation of the opening-closing cover in a case where the cartridge is insufficiently inserted to the apparatus main body (Japanese Patent No. 5773675).

In the image forming apparatus having the cartridge push-in unit, because the cartridge is pushed into the image forming position by using a force for closing the opening-closing cover, a large force is necessary for closing the opening-closing cover. In particular, in the image forming apparatus having a pressing spring for urging the cartridge to a normal position, the cartridge has to be inserted to the image forming position against the pressing force of the pressing spring. Hence, in a case where the cartridge is pushed into the image forming position with the opening-closing cover, a load necessary for operating the opening-closing cover is increased, so that usability thereof is lowered.

### SUMMARY OF THE INVENTION

According to an aspect of the present invention, an image forming apparatus includes a first unit including an image bearing member capable of rotating while bearing a toner image, a second unit including a development roller which supplies toner to the image bearing member to develop the toner image, an apparatus main body to which the first unit is detachably attached in a direction intersecting with a rotation axis of the image bearing member, the apparatus main body including an opening portion through which the first unit passes when the first unit is to be attached to or detached from the apparatus main body, an opening-closing member which can be moved to open or close the opening portion, a first portion which is in contact with a part of the first unit to position the first unit with respect to the apparatus main body, and a second portion, which does not move together with the opening-closing member, arranged on an opposite side of the first portion with respect to the image bearing member in the intersecting direction, and a sandwiched unit configured to be movable between a first position at which the sandwiched unit is sandwiched between the first unit and the second portion to press the first unit against the first portion and a second position at which the sandwiched unit is not sandwiched between the first unit and the second portion, wherein, when the sandwiched unit is located at the first position, a part of the first unit is urged and brought into contact with the first portion by the sandwiched unit.

According to another aspect of the present invention, a cartridge detachably attached to an apparatus main body of an image forming apparatus including an opening portion through which the cartridge passes when the cartridge is to be attached to the apparatus main body, an opening-closing member which can be moved to open or close the opening portion, a first portion which positions the cartridge with respect to the apparatus main body, and a second portion which does not move together with the opening-closing member, and a sandwiched unit which is sandwiched between the cartridge and the second portion, includes an image bearing member configured to bear a toner image, and a frame supporting the image bearing member so that the image bearing member is rotatable, wherein the frame member includes a sandwiching portion formed into a concave shape which sandwiches the sandwiched unit with the second portion in a case where the cartridge is attached to the apparatus main body.

Further features of the present invention will become apparent from the following description of exemplary embodiments with reference to the attached drawings.

### BRIEF DESCRIPTION OF THE DRAWINGS

FIG. 1 is a cross-sectional diagram of an apparatus main body of an image forming apparatus and a cartridge according to a first exemplary embodiment.

FIG. 2 is a cross-sectional diagram of the cartridge according to the first exemplary embodiment.

FIG. 3 is a perspective diagram of the image forming apparatus according to the first exemplary embodiment.

FIGS. 4A, 4B, and 4C are perspective diagrams of the cartridge according to the first exemplary embodiment.

FIG. 5 is a diagram illustrating the apparatus main body of the image forming apparatus and an insertion/removal track and positioning of the cartridge according to the first exemplary embodiment.

FIG. 6 is a cross-sectional diagram of the apparatus main body and the cartridge, which illustrates a state where a cartridge door of the image forming apparatus according to the first exemplary embodiment is opened or closed halfway.

FIG. 7 is a cross-sectional diagram of the apparatus main body and the cartridge, which illustrates a state where the cartridge door of the image forming apparatus according to the first exemplary embodiment is further closed than in the state in FIG. 6.

FIG. 8 is a cross-sectional diagram of the apparatus main body and the cartridge, which illustrates a state where the cartridge door of the image forming apparatus according to the first exemplary embodiment is closed.

FIG. 9 is a diagram illustrating an apparatus main body of an image forming apparatus and an insertion/removal track and positioning of a cartridge according to a second exemplary embodiment.

FIG. 10 is a cross-sectional diagram of the apparatus main body and the cartridge, which illustrates a state where a cartridge door of the image forming apparatus according to the second exemplary embodiment is opened or closed halfway.

FIG. 11 is a cross-sectional diagram of the apparatus main body and the cartridge, which illustrates a state where the cartridge door of the image forming apparatus according to the second exemplary embodiment is further closed than in the state in FIG. 10.

FIG. 12 is a cross-sectional diagram of the apparatus main body and the cartridge, which illustrates a state where the cartridge door of the image forming apparatus according to the second exemplary embodiment is closed.

FIG. 13 is a diagram illustrating an apparatus main body of an image forming apparatus and an insertion/removal track and positioning of a cartridge according to a third exemplary embodiment.

FIG. 14 is a cross-sectional diagram of the apparatus main body and the cartridge, which illustrates a state where a cartridge door of the image forming apparatus according to the third exemplary embodiment is opened or closed halfway.

FIG. 15 is a cross-sectional diagram of the apparatus main body and the cartridge, which illustrates a state where the cartridge door of the image forming apparatus according to the third exemplary embodiment is further closed than in the state in FIG. 14.

FIG. 16 is a cross-sectional diagram of the apparatus main body and the cartridge, which illustrates a state where the cartridge door of the image forming apparatus according to the third exemplary embodiment is closed.

FIG. 17 is an enlarged cross-sectional diagram illustrating a state where the cartridge of the image forming apparatus according to the third exemplary embodiment is pressed.

FIG. 18 is a diagram illustrating an apparatus main body of an image forming apparatus and an insertion/removal track and positioning of a cartridge according to a fourth exemplary embodiment.

FIG. 19 is an enlarged cross-sectional diagram illustrating a state where the cartridge of the image forming apparatus according to the fourth exemplary embodiment is pressed.

FIG. 20 is an enlarged cross-sectional diagram illustrating a state where the cartridge of the image forming apparatus according to the fourth exemplary embodiment is pressed.

FIG. 21 is a cross-sectional diagram of the apparatus main body and the cartridge, which illustrates a state where a cartridge door of the image forming apparatus according to the fourth exemplary embodiment is opened or closed halfway.

FIG. 22 is a cross-sectional diagram of the apparatus main body and the cartridge, which illustrates a state where the cartridge door of the image forming apparatus according to the fourth exemplary embodiment is further closed than in the state in FIG. 21.

FIG. 23 is a cross-sectional diagram of the apparatus main body and the cartridge, which illustrates a state where the cartridge door of the image forming apparatus according to the fourth exemplary embodiment is closed.

FIG. 24 is an enlarged cross-sectional diagram illustrating a state where a cartridge of an image forming apparatus according to a variation example of the fourth exemplary embodiment is pressed.

FIGS. 25A and 25B are perspective diagrams partially illustrating one of side plates of an apparatus main body of an image forming apparatus according to a fifth exemplary embodiment.

### DESCRIPTION OF THE EMBODIMENTS

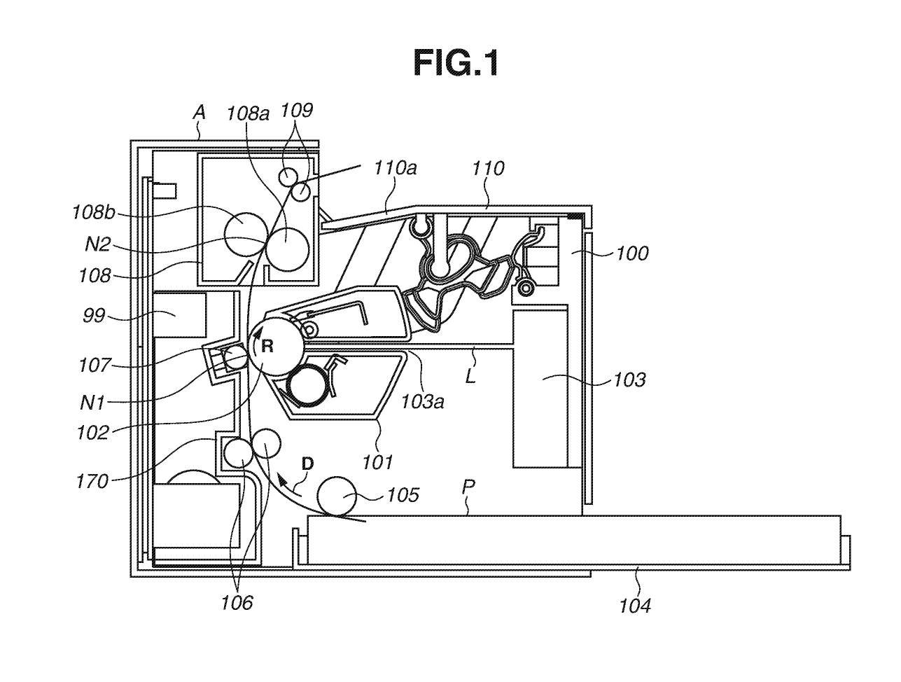

Hereinafter, an exemplary embodiment of the present invention will be described in detail with reference to the appended drawings. A rotation axis line direction of an electrophotographic photosensitive drum (photosensitive drum) is defined as a lengthwise direction. Further, in the lengthwise direction, a side on which the photosensitive drum receives a driving force from the apparatus main body is defined as a drive side, whereas another side thereof is defined as a non-drive side. A general configuration and image forming processing will be described with reference to FIG. 1. FIG. 1 is a cross-sectional diagram of an apparatus main body A of the image forming apparatus according to the present exemplary embodiment. Herein, the apparatus main body A refers to a portion of the image forming apparatus excluding a cartridge 101.

### <General Configuration of Image Forming Apparatus>

An image forming apparatus in FIG. 1 is a laser beam printer using an electrophotographic technique, which includes a process cartridge (cartridge) 101 freely attached to or detached from the apparatus main body A. First, a general configuration of the image forming apparatus will be simply described. An exposure device 103 for forming a latent image on a rotatable photosensitive drum 102 of the cartridge 101 is arranged on the apparatus main body A. Further, a sheet feeding tray 104 which stores a recording material P serving as an image forming target is arranged on the lower side of the cartridge 101. Further, the apparatus main body A includes a feeding roller 105, a conveyance roller pair 106, a transfer roller 107, a fixing unit 108, a discharge roller pair 109, and a discharged sheet stacking face 110a which are arranged in a conveyance direction D of the recording material P. In addition, the fixing unit 108 is configured of a heating roller 108a and a pressure roller 108b. Further, a signal substrate 99 for transmitting or receiving various signals is arranged on a face opposite to a conveyance face of a conveyance frame 170. Although the cartridge 101 is held by the apparatus main body A, a holding structure thereof will be described below in detail.

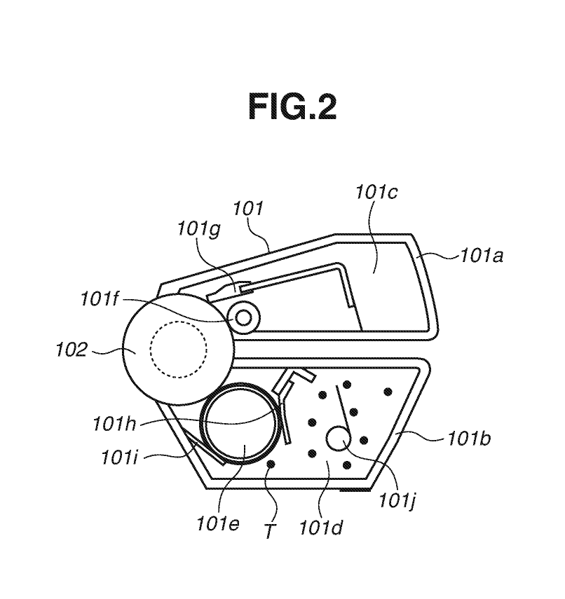

FIG. 2 is a cross-sectional diagram of the cartridge 101. The cartridge 101 mainly includes a drum unit (first unit) 101a and a development unit (second unit) 101b. The drum unit 101a includes a cleaning container 101c1 having a waste toner chamber 101c, and the photosensitive drum (image bearing member) 102, a charging roller 101f, and a cleaning blade 101g are held by the cleaning container 101c1. The development unit 101b includes a development container 101d1 having a toner chamber 101d filled with toner T, and a development roller 101e, a development blade 101h, a leakage prevention sheet 101i, and a conveyance member 101j are held by the development container 101d1.

### <Image Forming Processing>

Next, an outline of the image forming processing will be described with reference to FIGS. 1 and 2. First, a motor (not illustrated) starts rotating based on a print start signal transmitted from the signal substrate 99, so that the photosensitive drum 102 is rotationally driven in a direction indicated by an arrow R at a predetermined circumferential speed (processing speed).

The charging roller 101f, to which bias voltage supplied from a power supply apparatus is applied, is in contact with an outer circumferential surface of the photosensitive drum 102, and uniformly charges the outer circumferential surface of the photosensitive drum 102. The exposure device 103 outputs laser light L according to image information. The laser light L passes through a laser opening 103a formed in a space between the drum unit 101a and the development unit 101b of the cartridge 101, so that the outer circumferential surface of the photosensitive drum 102 is exposed to and scanned with the laser light L. Through the above processing, an electrostatic latent image corresponding to the image information is formed on the outer circumferential surface of the photosensitive drum 102.

On the other hand, in the development unit 101b, the toner T contained in the toner chamber 101d is agitated and conveyed through the rotation of the conveyance member 101j and borne on a surface of the development roller 101e.

While the toner T is frictionally charged by the development blade 101h, a layer thickness of the toner T on the circumferential surface of the development roller 101e serving as a developer bearing member is regulated. The toner T is supplied to the photosensitive drum 102, so that the electrostatic latent image is visualized as a toner-T image.

Further, the sheet feeding roller 105 and the conveyance roller pair 106 feed a recording material P stored in the sheet feeding tray 104 arranged in the lower portion of the apparatus main body A while adjusting a timing with an output timing of the laser light L. Then, the recording material P is conveyed to a transfer nip N1 between the photosensitive drum 102 and the transfer roller 107 along the conveyance frame 170. At the transfer nip N1, the toner-T image borne on the photosensitive drum 102 is sequentially transferred to the recording material P from the photosensitive drum 102.

The recording material P on which the toner-T image is transferred is separated from the photosensitive drum 102 and conveyed to the fixing unit 108. Then, the recording material P passes through a fixing nip N2 between the heating roller 108a and the pressure roller 108b which constitute the fixing device. At the fixing nip N2, fixing processing is executed by applying heat and pressure to the recording material P, so that the toner-T image is fixed on the recording material P. The recording material P on which the fixing processing of the toner-T image is executed is conveyed to the discharge roller pair 109 and discharged to the discharged sheet stacking face 110a.

Toner T remaining on the outer circumferential surface of the photosensitive drum 102 after transfer processing is removed by the cleaning blade 101g, and the photosensitive drum 102 is used for image forming processing again. The toner T removed from the photosensitive drum 102 is stored in the waste toner chamber 101c of the drum unit 101a.

In the above, the charging roller 10f, the development roller 101e, the transfer roller 107, and the cleaning blade 101g are processing units acting on the photosensitive drum 102.

### <Configuration for Pressing Cartridge>

When the user continuously executes printing, toner T in the cartridge 101 is consumed and eventually used up, so that printing will not be executable. The user, therefore, opens the cartridge door (opening-closing member) 110, removes the cartridge 101 without containing toner T from a formed opening portion 666, inserts a new cartridge 101, and closes the cartridge door 110 to replace the cartridge 101. At this time, there is a risk in which the cartridge 101 remains, in the course of loading processing, in a position along the way to the image forming position where image forming processing is executable. The cartridge 101 is, therefore, pressed by relay members (sandwiched unit) 127a and 127b arranged on the cartridge door 110 and urged to the image forming position of the apparatus main body A. A configuration of urging the cartridge 101 with the relay members 127a and 127b will be specifically described.

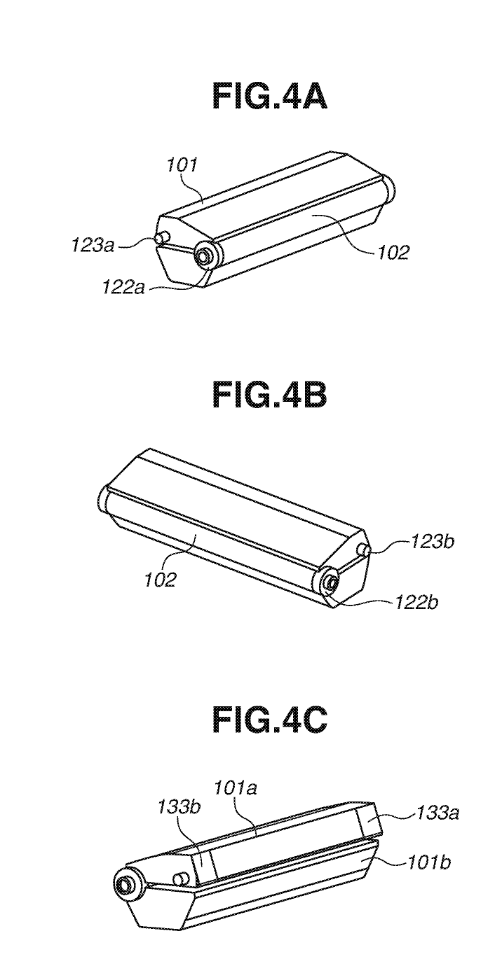

As illustrated in FIGS. 4A, 4B, and 4C, the cartridge 101 includes positioning portions (first portions) 122a and 122b for enabling the photosensitive drum 102 to be positioned at a position where image forming processing is executable, at both ends in the axis line direction of the photosensitive drum 102. Each of the positioning portions 122a and 122b is formed into a cylindrical shape having an axis that is the same as the axis of the photosensitive drum 102. In addition, in order to prevent the cartridge 101 from rotating by making the positioning portions 122a and 122b as the rotation center, the cartridge 101 includes rotation stopper portions 123a and 123b. In the present exemplary embodiment, although the rotation stopper portions 123a and 123b are arranged at both ends of the cartridge 101 in the axis line direction of the photosensitive drum 102, the cartridge 101 may include at least any one of the rotation stopper portions 123a and 123b.

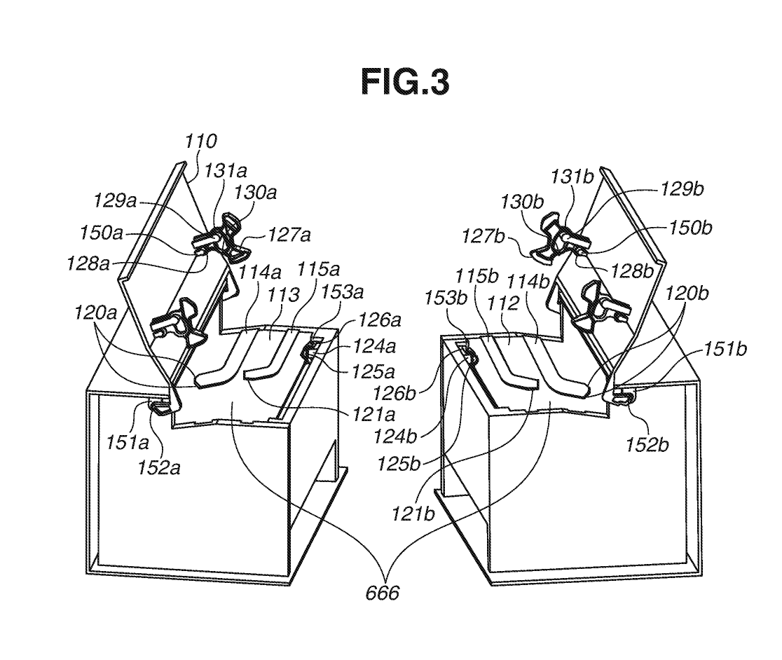

On the other hand, as illustrated in FIG. 3, a side plate 113 of the apparatus main body A has guides 114a and 115a which guide the cartridge 101 when the cartridge 101 is to be attached or detached. Similarly, a side plate 112 has guides 114b and 115b which guide the cartridge 101 when the cartridge 101 is to be attached or detached. The cartridge 101 can be positioned at a position where image formation is executable, by the guides 114a, 114b, 115a, and 115b.

The guide 114a guides the positioning portion 122a of the cartridge 101 to make the positioning portion 122a abut on an abutting portion 120a to position the cartridge 101. Similarly, the guide 114b guides the positioning portion 122b of the cartridge 101 to make the positioning portion 122b abut on an abutting portion 120b to position the cartridge 101.

Then, the guide 115a guides the rotation stopper portion 123a of the cartridge 101 to make the rotation stopper portion 123a abut on a rotation regulation portion 121a of the guide 115a to regulate rotation of the cartridge 101. Similarly, the guide 115b guides the rotation stopper portion 123b of the cartridge 101 to make the rotation stopper portion 123b abut on a rotation regulation portion 121b of the guide 11b to regulate rotation of the cartridge 101.

Door rotation shafts 152a and 152b of the cartridge door 110 respectively are held by shaft bearings 151a and 151b of the apparatus main body A, so that the cartridge door 110 can rotate to open or close the opening portion 666 through which the cartridge 101 enters an inner space of the apparatus main body A. The cartridge 110 passes through the opening portion 666 when the cartridge 110 is mounted on the apparatus main body A. In the present exemplary embodiment, the relay members 127a and 127b are arranged on a face of the cartridge door 110 which faces the abutting portion 120b or a space inside the apparatus main body A where the cartridge 101 enters. The relay member 127a is arranged on one end of the cartridge door 110 in the lengthwise direction. The relay member 127b is arranged on another end of the cartridge door 110 in the lengthwise direction and has a configuration similar to the relay member 127a. Hereinafter, a configuration relating to the relay member 127a and a periphery of the relay member 127a will therefore be described in detail, and description with respect to a configuration relating to the relay member 127b and a periphery of the relay member 127b will be omitted. Description and illustration will be provided while a symbol “a” is added to the reference numeral with respect to the configuration relating to the relay member 127a whereas a symbol “b” is added to the reference numeral with respect to the configuration relating to the relay member 127b.

A shaft 150a extending in parallel with the door rotation shafts 152a and 152b is arranged on a face of the cartridge door 110 which faces the space inside the apparatus main body A where the cartridge 101 enters, and a shaft bearing portion that engages with the shaft 150a is arranged on the relay member 127a. With this configuration, the relay member 127a can be rotationally moved by making the shaft 150a as a center. In other words, the relay member 127a can be moved with respect to the cartridge door 110. The relay member 127a has a rotation regulation hole, and a rotation regulation boss 129a arranged on the cartridge door 110 can move inside the rotation regulation hole. Thereby, an angle at which the relay member 127a can move rotationally is regulated. A pressing face 141a and a pressed face 142a are arranged on the relay member 127a in the order from a side of the rotation center of the cartridge door 110.

A pressing lever 125a held by the apparatus main body A in a rotationally movable state and a pressing spring 124a serving as an elastic member for urging the pressing lever 125a, which is arranged in a space between a main body frame 100 of the apparatus main body A and the pressing lever 125a, are arranged on the apparatus main body A. The pressing lever 125a is capable of being in contact with the pressed face 142a, and when the pressing lever 125a is in contact with the pressed face 142a to urge the pressed face 142a, the urging force is transmitted to the pressed face 133a of the cartridge 101 via the pressing face 141a, so that the cartridge 101 is inserted to the image forming position. The pressing lever 125a includes a temporary retaining portion 126a which engages with a temporary retained portion 153a arranged on the main body frame 100 of the apparatus main body A. As described above, the position of the pressing lever 125a urged by the pressing spring 124a can be regulated.

A pressing lever 125b having a configuration similar to that of the pressing lever 125a and a pressing spring 124b for urging the pressing lever 125b are arranged on the apparatus main body A. With this configuration, the urging force of the pressing spring 124b is transmitted to the cartridge 101 via the pressing lever 125b and the relay member 127b, so that the cartridge 101 is inserted to the image forming position.

### <Attachment of Cartridge to Image Forming Apparatus>

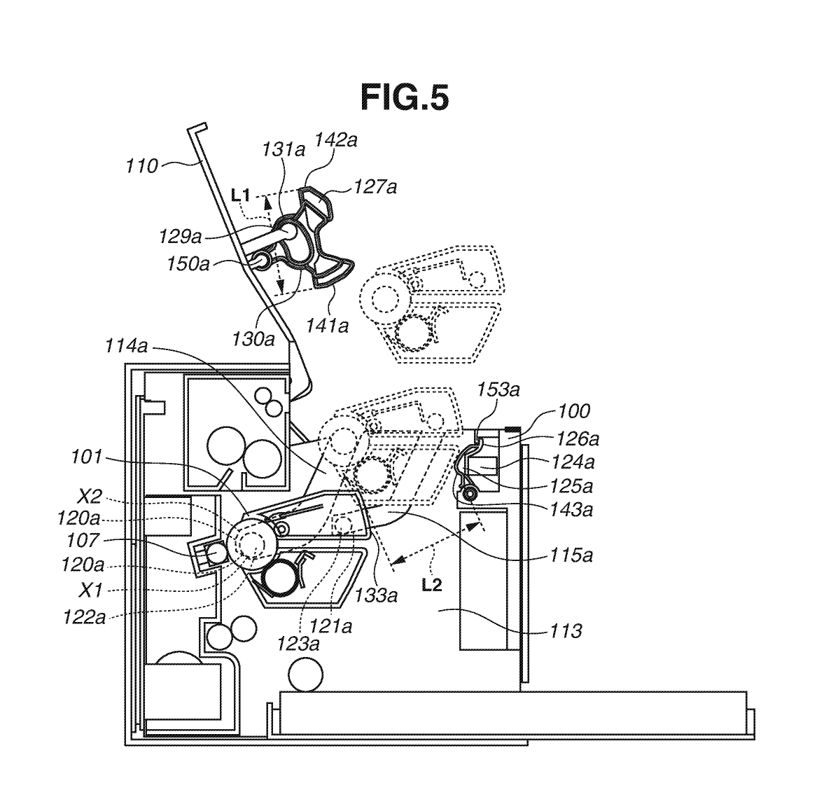

Next, with reference to FIGS. 5 to 9, an operation of urging and inserting the cartridge 101 to the image forming position by the relay member 127a after the user opens the cartridge door 110 to insert the cartridge 101 from the formed opening portion 666 will be sequentially described. Herein, only a configuration of the drive side will be described. However, a configuration and an operation of the non-drive side are similar to those of the drive side unless otherwise specifically described.

The user opens the cartridge door 110 and inserts the cartridge 101 to make the positioning portion 122a and the rotation stopper portion 123a of the cartridge 101 respectively held by the guides 114a and 115a of the apparatus main body A. An orientation of the cartridge 101 is determined when the cartridge 101 is held by the two guides 114a and 115a, and the cartridge 101 is moved according to the shapes of the guides 114a and 115a. Accordingly, the cartridge 101 is moved while following a cartridge insertion/removal (attachment/detachment) track as illustrated in FIG. 5. At this time, the pressing lever 125a is held by the apparatus main body A at a position outside the insertion/removal track of the cartridge 101. When the cartridge door 110 is opened, the relay member 127a is held at a position (second position) outside the insertion/removal track of the cartridge 101 in an orientation in which the rotation regulation boss 129a is in contact with a regulation face 131a of the rotation regulation hole because of the gravitational force.

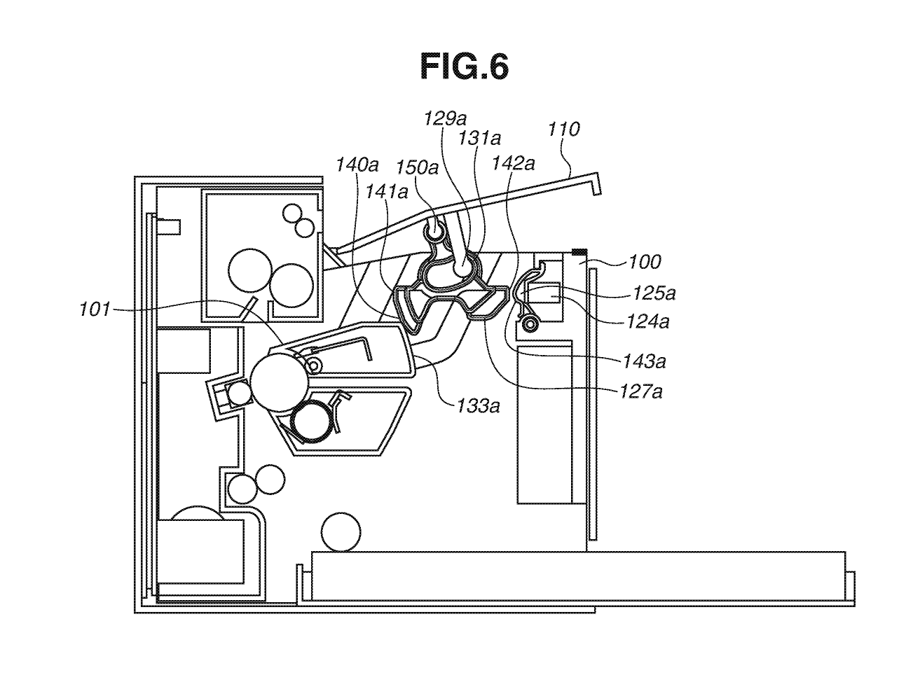

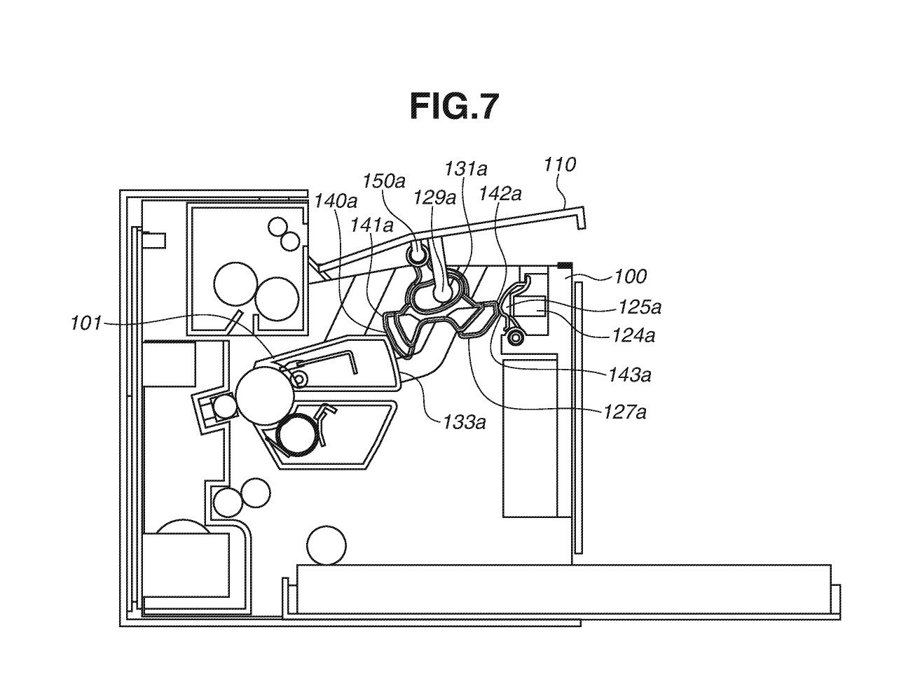

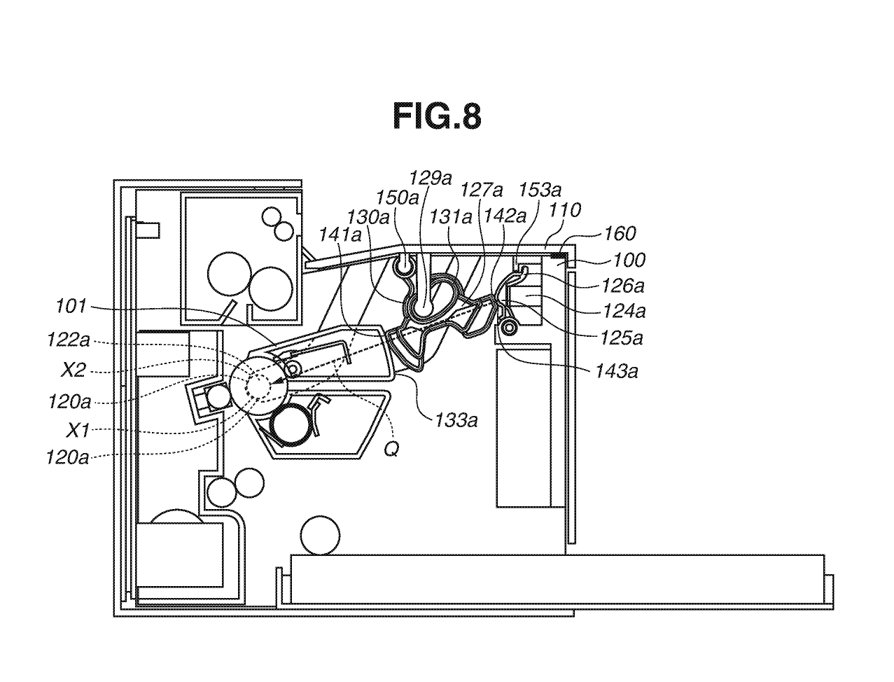

As illustrated in FIG. 6, when the user inserts the cartridge 101 to the apparatus main body A and executes a closing operation of the cartridge door 110 to move the cartridge door 110 from the opening position to the closing position, the pressing face 141a of the relay member 127a is in contact with the pressed face 133a of the cartridge 101. When the closing operation of the cartridge door 110 is further executed, the rotation regulation boss 129a is separated from the regulation face 131a of the rotation regulation hole to move along the inner surface of the rotation regulation hole, so that the relay member 127a is rotated. Then, when the closing operation is further executed, the pressed face 142a of the relay member 127a is in contact with the pressing lever 125a while the pressing face 141a of the relay member 127a is in contact with the pressed face 133a of the cartridge 101 (see FIG. 7). By further executing the closing operation of the cartridge door 110 in the above state, the cartridge door 110 is eventually moved to the closing position (see FIG. 8). As illustrated in FIG. 5, a distance L between the pressing face 141a and the pressed face 142a of the relay member 127a is longer than a distance L2 between the pressed face 133a of the cartridge 101 and the pressing face (second portion) 143a of the pressing lever 125a. Therefore, when the cartridge 101 is urged by the relay member 127a, a position of the cartridge 101 is regulated by the abutting portion 120a of the apparatus main body A. The pressing face 143a of the pressing lever 125a is arranged on the opposite side of the positioning portion 122a with respect to the photosensitive drum 102 in a direction intersecting with the rotation axis line of the photosensitive drum 102.

On the other hand, when the pressing lever 125a is urged by the relay member 127a, the pressing lever 125a compresses and deforms the pressing spring 124a to rotationally move. As described above, the temporary retaining portion 126a of the pressing lever 125a is separated from the temporary retained portion 153a arranged on the main body frame 100 of the apparatus main body A. As a result, the urging force of the pressing spring 124a is transmitted to the cartridge 101 via the pressing lever 125a. As described above, when the cartridge door 110 is located at the closing position, the relay member 127a is located at a position (first position) where the relay member 127a is held between the pressed face 133a of the cartridge 101 (drum unit 101a) and the pressing face 143a of the pressing lever 125a. The relay member 127a urges the cartridge 101 at the first position to make the cartridge 101 abut on the abutting portion 120a of the apparatus main body A, so that the position of the cartridge 101 with respect to the apparatus main body A is determined.

In the present exemplary embodiment, the abutting portion 120a is formed into a V-shape consisting of inclined planes X1 and X2. When the cartridge door 110 is located at the opening position, and the relay member 127a is located outside the insertion/removal track of the cartridge 101, the positioning portion 122a is not in contact with the inclined plane X2 of the abutting portion 120a of the apparatus main body A due to the own weight of the cartridge 101 and the pressing of the transfer roller 107. However, when the cartridge 101 is urged by the relay member 127a, the positioning portion 122a of the cartridge 101 (drum unit 101a) moves on the inclined plane X1 due to the pressing force of the pressing spring 124a until the positioning portion 122a is in contact with the inclined plane X2 of the abutting portion 120a. As a result, movement of the positioning portion 122a of the cartridge 101 is stopped in a state where the positioning portion 122a is in contact with both of the inclined planes X1 and X2, so that the photosensitive drum 102 can be placed at a position where image forming processing is executable.

In the present exemplary embodiment, a contact face between the pressing face 142a of the relay member 127a and the pressing face 143a of the pressing lever 125a and a contact face between the pressing face 141a of the relay member 127a and the pressed face 133a of the cartridge 101 are aligned in a straight line. Then, a vector Q of the pressing force generated by the pressing spring 124a extends along the straight line toward the center of the photosensitive drum 102, and passes through a position between the inclined planes X1 and X2 of the V-shaped abutting portion 120a. In the present exemplary embodiment, the cartridge 101 can therefore be stably held. On the other hand, because the shaft 150a of the relay member 127a is not located at a position in the straight line along which the vector Q extends, the relay member 127a is rotated to transmit a driving force to the cartridge 101. As described above, the photosensitive drum 102 is positioned at a position where image forming processing is executable, so that a position of the cartridge 101 can be stably retained.

<Detachment of Cartridge from Image Forming Apparatus>

A configuration for taking out the cartridge 101 from the apparatus main body A will be described. Herein, only a configuration of the drive side will be described. However, a configuration and an operation of the non-drive side are similar to those of the drive side unless otherwise specifically described. An operation opposite to the above-described operation of inserting the cartridge 101 will be executed as an operation of taking out the cartridge 101 from the apparatus main body A. In other words, an opening operation of the cartridge door 110 is executed in a state where the cartridge 101 is located at an image forming position, while the relay member 127a is in contact with both of the cartridge 101 and the pressing lever 125a as illustrated in FIG. 8. When the opening operation of the cartridge door 110 is executed, the relay member 127a is separated from the pressing lever 125a (see FIG. 7). Then, the relay member 127a is separated from the cartridge 101, so that the rotation regulation boss 129a is eventually brought into contact with the regulation face 131a of the rotation regulation hole. Then, when the cartridge door 110 is located at the opening position, the relay member 127a is moved to a position outside the insertion/removal track of the cartridge 101, as illustrated in FIG. 5.

Accordingly, the cartridge 101 can be taken out from the inner portion of the apparatus main body A without being in contact with the relay member 127a and the pressing lever 125a that press and hold the cartridge 101. Specifically, in the present exemplary embodiment, the relay member 127a is inserted in a direction intersecting with the pressing direction of the cartridge 101. Thus, although the cartridge 101 is urged by elastically deforming the elastic member through the closing operation of the cartridge door 110, it is possible to reduce a strength necessary for the replacement work of the cartridge 101. Further, in the present exemplary embodiment, the pressed face 133a of the cartridge 101 which is in contact with the relay member 127a is formed into an arc-like shape having the rotation center that is the same as the rotation center of the photosensitive drum 102. With this configuration, a force for operating the cartridge door 110 can be further reduced. As described above, the cartridge 101 can be stably held in the apparatus main body A at the time of image formation, and a strength necessary for replacing the cartridge 101 is reduced. Usability thereof can therefore be improved.

In the first exemplary embodiment, the relay members 127a and 127b move rotationally. However, the configuration is not limited thereto, and the relay member may move in a sliding manner. Therefore, as a second exemplary embodiment, a relay member that moves in a sliding manner will be described. In addition, a reference numeral that is the same as the reference numeral in the first exemplary embodiment is applied to a configuration similar to that of the first exemplary embodiment, and description thereof will be omitted. Herein, only a configuration of the drive side will be described. However, a configuration and an operation of the non-drive side are similar to those of the drive side unless otherwise specifically described.

### <Configuration for Pressing Cartridge>

Similar to the first exemplary embodiment, a cartridge door 210 is held by a shaft bearing of the apparatus main body A in a rotationally movable state, and a relay member 227a is arranged on a face of the cartridge door 210 which faces a space inside the apparatus main body A where the cartridge 101 enters. More specifically, supporting portions 211a and 212a are arranged on a face of the cartridge door 210 which faces a space inside the apparatus main body A where the cartridge 101 enters. Then, the relay member 227a includes an elongate hole 240a, and the supporting portions 211a and 212a are arranged to engage with an internal portion of the elongate hole 240a. With this configuration, the relay member 227a can move in a sliding manner in a direction intersecting with a rotation axis of the cartridge door 210 with respect to the supporting portions 211a and 212a as well as the cartridge door 210. Similar to the first exemplary embodiment, a pressing face 241a and a pressed face 242a are arranged on the relay member 227a in the order from a side of the rotation center of the cartridge door 210. The pressing lever 125a is capable of being in contact with the pressed face 242a, and when the pressing lever 125a is in contact with the pressed face 242a to urge the pressed face 242a, the urging force is transmitted to a pressed face 133a of the cartridge 101 via the pressing face 241a, so that the cartridge 101 is inserted to the image forming position.

### <Attachment of Cartridge to Image Forming Apparatus>

Next, with reference to FIGS. 5 to 9, an operation of urging and inserting the cartridge 101 to the image forming position by the relay member 227a after the user opens the cartridge door 210 to insert the cartridge 101 from the formed opening portion 666 will be sequentially described.

The user opens the cartridge door 210 and inserts the cartridge 101 to make the positioning portion 122a and the rotation stopper portion 123a of the cartridge 101 respectively held by the guides 114a and 115a of the apparatus main body A. An orientation of the cartridge 101 is determined when the cartridge 101 is held by the two guides 114a and 115a, and the cartridge 101 is moved according to the shapes of the guides 114a and 115a. Accordingly, the cartridge 101 is moved while following an insertion/removal track of the cartridge 101 as illustrated in FIG. 5. At this time, the pressing lever 125a is held by the apparatus main body A at a position outside the insertion/removal track of the cartridge 101. When the cartridge door 210 is opened, the relay member 227a is held at a position outside the insertion/removal track of the cartridge 101 in an orientation in which the supporting portion 211a is in contact with a regulation face 231a of the elongate hole 240a because of the gravitational force. As a result, insertion or removal of the cartridge 101 will not be interrupted because the relay member 227a is located at a position outside the insertion/removal track of the cartridge 101. Accordingly, when the cartridge 101 is to be inserted, the cartridge 101 can be inserted to the apparatus main body A without being in contact with the pressing lever 125a or the relay member 227a that presses the cartridge 101.

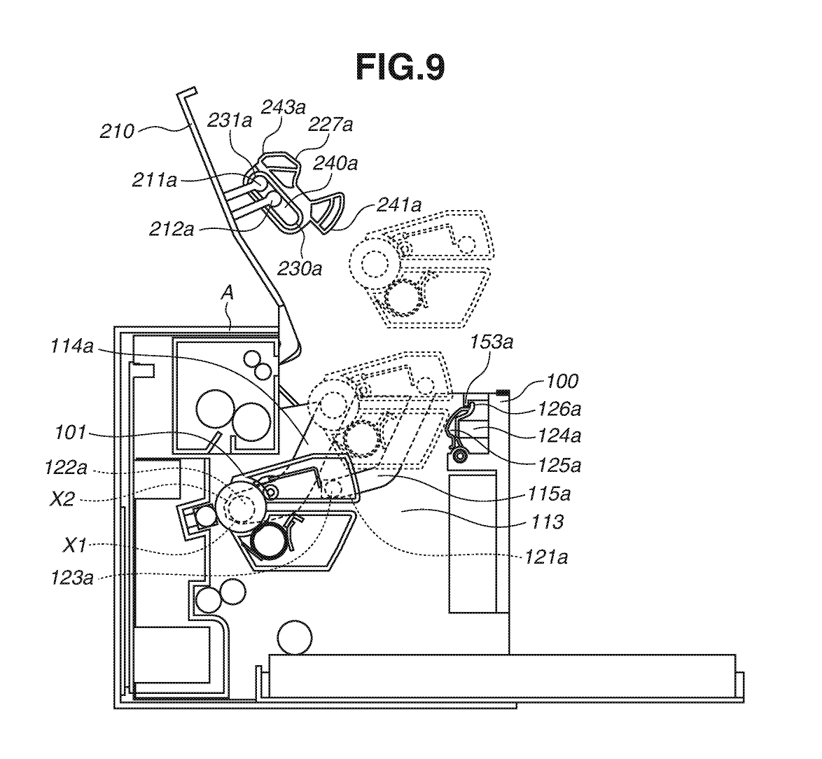

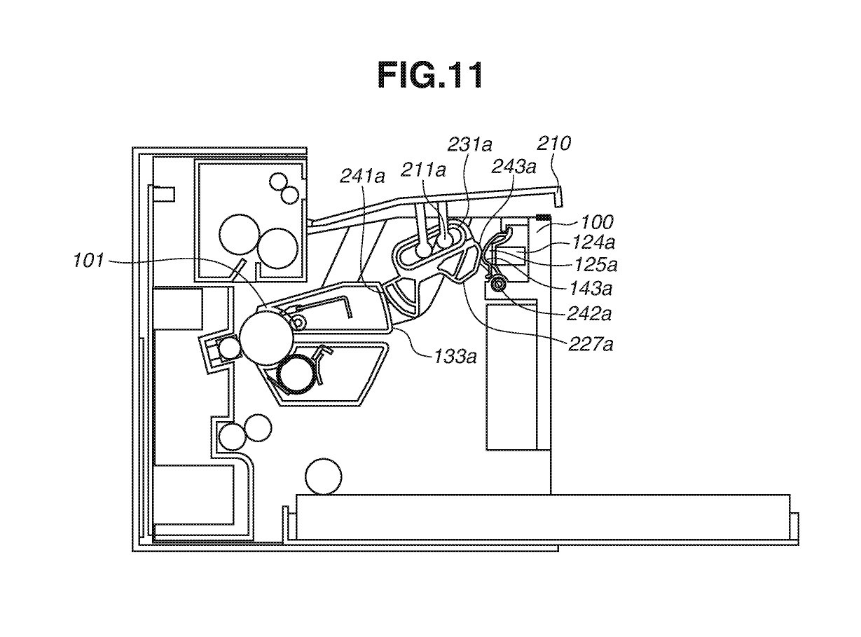

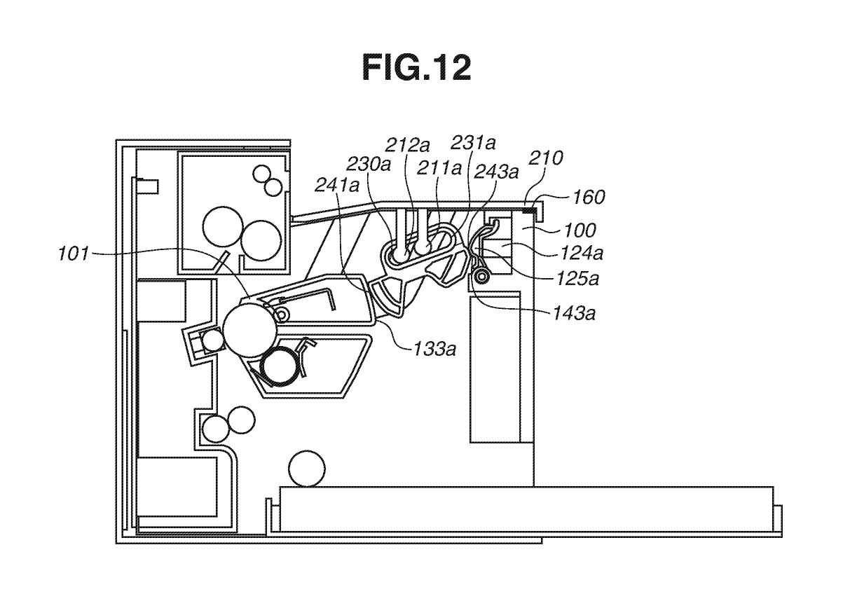

As illustrated in FIG. 9, when the user inserts the cartridge 101 to the apparatus main body A and executes a closing operation of the cartridge door 210 to move the cartridge door 210 from the opening position to the closing position, the pressing face 241a of the relay member 227a is in contact with the pressed face 133a of the cartridge 101. When the closing operation of the cartridge door 210 is further executed, the relay member 227a starts moving in a sliding manner with respect to the cartridge door 210, and the supporting portion 211a is separated from the regulation face 231a of the elongate hole 240a. Then, when the closing operation is further executed, the pressed face 242a of the relay member 227a is in contact with the pressing lever 125a while the pressing face 241a of the relay member 227a is in contact with the pressed face 133a of the cartridge 101 (see FIG. 11). By further executing the closing operation of the cartridge door 210 in the above state, the cartridge door 210 is eventually moved to the closing position (see FIG. 12).

<Detachment of Cartridge from Image Forming Apparatus>

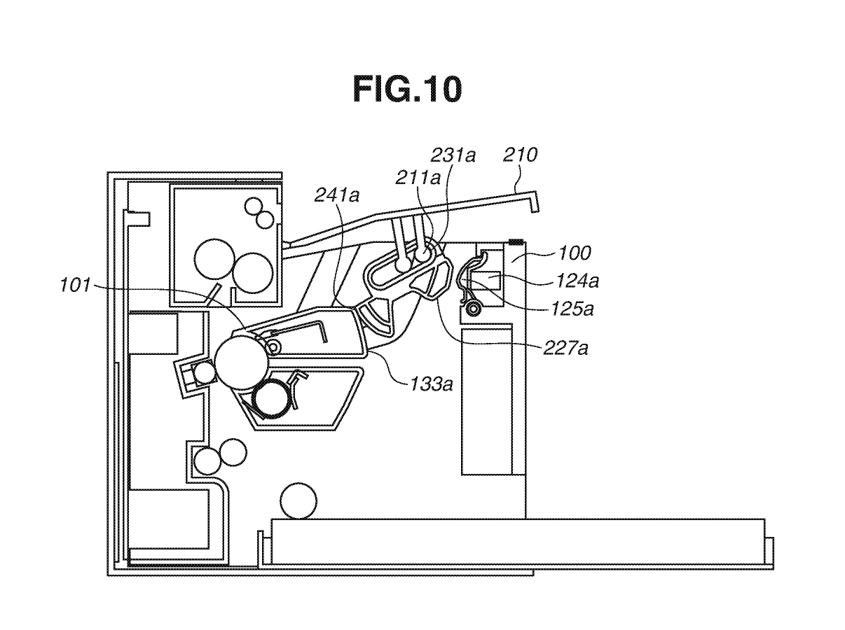

A configuration for taking out the cartridge 101 from the apparatus main body A will be described. An operation opposite to the above-described operation of inserting the cartridge 101 will be executed as an operation of taking out the cartridge 101 from the apparatus main body A. In other words, an opening operation of the cartridge door 210 is executed in a state where the cartridge 101 is located at an image forming position, and the relay member 227a is in contact with both of the cartridge 101 and the pressing lever 125a as illustrated in FIG. 12. When the opening operation of the cartridge door 210 is executed, the relay member 227a is separated from the pressing lever 125a (see FIG. 10). Then, the relay member 227a is separated from the cartridge 101, so that the supporting portion 211a is eventually brought into contact with the regulation face 131a of the elongate hole 240a. Then, when the cartridge door 210 is located at the opening position, the relay member 227a is moved to a position outside the insertion/removal track of the cartridge 101 as illustrated in FIG. 9.

Accordingly, the cartridge 101 can be taken out from the inner portion of the apparatus main body A without being in contact with the relay member 227a and the pressing lever 125a that press and hold the cartridge 101. Specifically, in the present exemplary embodiment, the relay member 227a is inserted in a direction intersecting with the pressing direction of the cartridge 101. Therefore, although the cartridge 101 is urged by elastically deforming the elastic member through the closing operation of the cartridge door 210, it is possible to reduce a strength necessary for the replacement work of the cartridge 101.

In the present exemplary embodiment, the two supporting portions 211a and 212a are located inside the elongate hole 240a, and the relay member 227a can move in a sliding manner by a predetermined width with respect to the cartridge door 210. However, a configuration in which the relay member 227a does not move rotationally with respect to the cartridge door 210 is not limited to the above. For example, one supporting portion formed into a substantially rectangular shape may be arranged inside the elongate hole 240a, so that the relay member 227a may slide with respect to the cartridge door 210 without moving rotationally.

In the first exemplary embodiment, the urging member is arranged on the apparatus main body, and an urging force generated by the urging member is applied to the cartridge via the relay member arranged on the cartridge door. However, the configuration is not limited thereto, and the elastic member may be arranged on the relay member. Therefore, as a third exemplary embodiment, a configuration of a relay member having an elastic member will be described. In addition, a reference numeral that is the same as the reference numeral in the first exemplary embodiment is applied to a configuration similar to that of the first exemplary embodiment, and description thereof will be omitted. Herein, only a configuration of the drive side will be described. However, a configuration and an operation of the non-drive side are similar to those of the drive side unless otherwise specifically described.

### <Configuration for Pressing Cartridge>

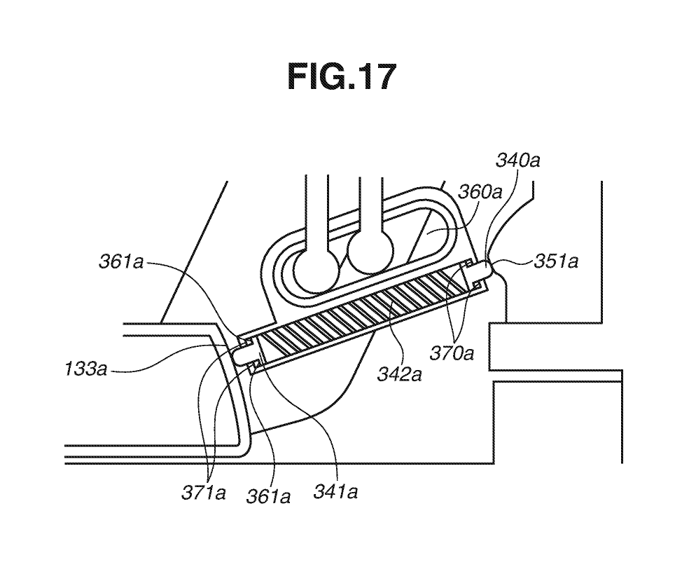

Similar to the first exemplary embodiment, a cartridge door 310 is held by a shaft bearing of the apparatus main body A in a rotationally movable state, and a relay member 327a is arranged on a face of the cartridge door 310 which faces a space inside the apparatus main body A where the cartridge 101 enters. More specifically, supporting portions 311a and 312a are arranged on a face of the cartridge door 310 which faces a space inside the apparatus main body A where the cartridge 101 enters. Then, the relay member 327a includes an elongate hole 360a, and the supporting portions 311a and 312a are arranged to engage with an internal portion of the elongate hole 360a. With this configuration, the relay member 327a can move in a sliding manner with respect to the supporting portions 311a and 312a as well as the cartridge door 310. In the present exemplary embodiment, the relay member 327a includes a pressing spring 342a serving as an elastic member, and a pressing member 340a is arranged on one end of the pressing spring 342a positioned on a side of the rotation center of the cartridge door 101, whereas a pressing member 341a is arranged on another end thereof (see FIG. 17). With this configuration, the pressing spring 342a of the relay member 327a applies a certain spring pressure in a direction in which the pressing members 340a and 341a are separated from each other. Furthermore, the pressing members 340a and 341a of the relay member 327a respectively are held by retaining portions 370a and 371a, so that the pressing members 340a and 341a are prevented from coming off.

On the other hand, the pressing lever 125a and the pressing spring 124a serving as an elastic member for urging the pressing lever 125a, which are arranged on the apparatus main body A in the first exemplary embodiment, are not arranged thereon, and an inner wall face of the main body frame 100 of the apparatus main body A faces a space to which the cartridge 101 is to be inserted. With this configuration, the relay member 327a can be inserted between the cartridge 101 and the main body frame 100 of the apparatus main body A. In other words, the pressing member 340a located at one end of the pressing spring 342a can be in contact with a pressed portion 351a of the main body frame 100, whereas the pressing member 341a located at another end of the pressing spring 342a can be in contact with the pressed face 133a of the cartridge 101. As described above, the cartridge 101 is urged and inserted to the image forming position.

### <Attachment of Cartridge to Image Forming Apparatus>

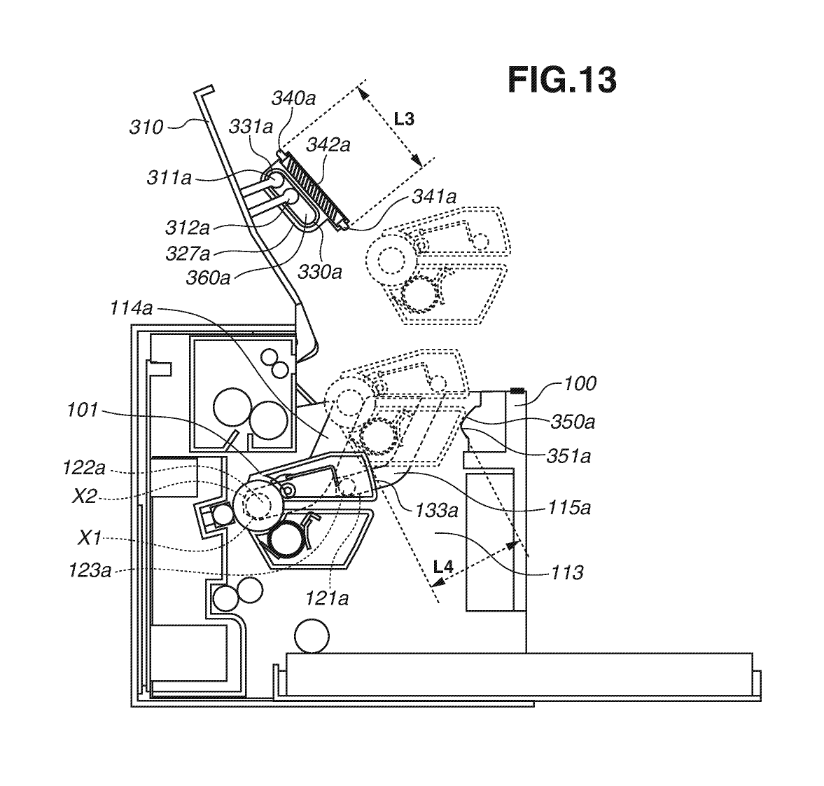

Next, with reference to FIGS. 13 to 18, an operation of urging and inserting the cartridge 101 to the image forming position by the relay member 327a after the user opens the cartridge door 310 to insert the cartridge 101 from the formed opening portion 666 will be sequentially described.

The user opens the cartridge door 310 and inserts the cartridge 101 to make the positioning portion 122a and the rotation stopper portion 123a of the cartridge 101 respectively held by the guides 114a and 115a of the apparatus main body A. An orientation of the cartridge 101 is determined when the cartridge 101 is held by the two guides 114a and 115a, and the cartridge 101 is moved according to the shapes of the guides 114a and 115a. Accordingly, the cartridge 101 is moved while following an insertion/removal track of the cartridge 101 as illustrated in FIG. 13. When the cartridge door 310 is opened, the relay member 327a is held at a position outside the insertion/removal track of the cartridge 101 in an orientation in which the supporting portion 3111a is in contact with a regulation face 331a of the elongate hole 360a because of the gravitational force.

As a result, an insertion or removal of the cartridge 101 will not be interrupted because the relay member 327a is located at a position outside the insertion/removal track of the cartridge 101. Accordingly, when the cartridge 101 is to be inserted, the cartridge 101 can be inserted into the apparatus main body A without being in contact with the relay member 327a.

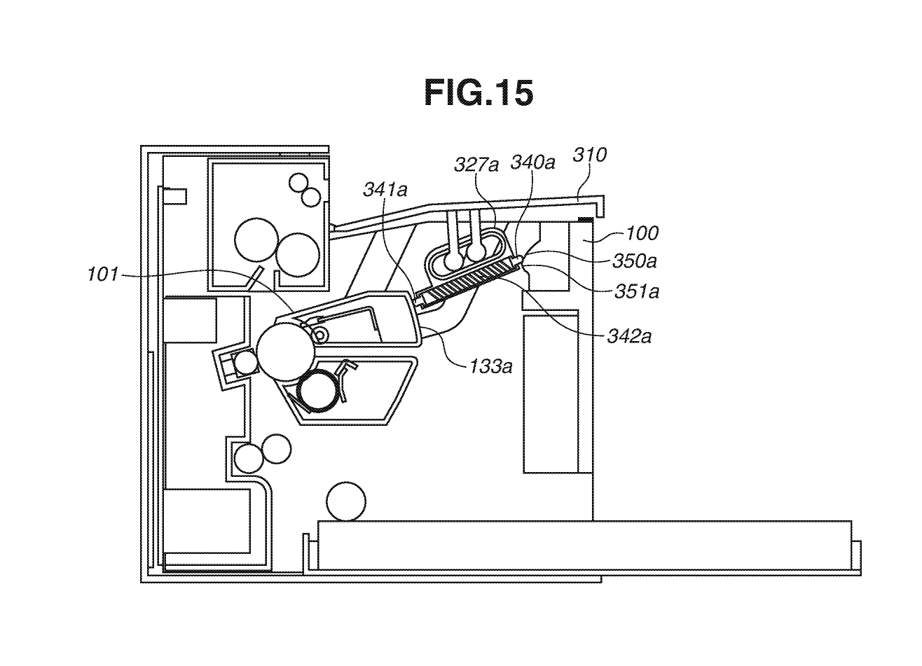

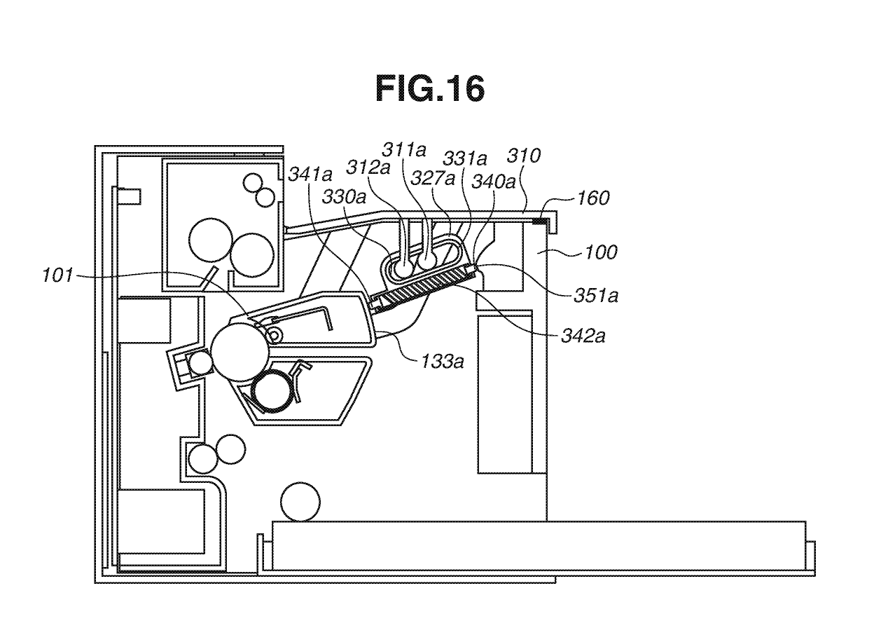

As illustrated in FIG. 13, when the user inserts the cartridge 101 to the apparatus main body A and executes the closing operation of the cartridge door 310 to move the cartridge door 310 from the opening position to the closing position, the pressing member 341a of the relay member 327a is in contact with the pressed face 133a of the cartridge 101. When the closing operation of the cartridge door 310 is further executed, the relay member 327a starts moving in a sliding manner with respect to the cartridge door 310, and the supporting portion 311a is separated from the regulation face 331a of the elongate hole 360a. At this time, the relay member 327a moves in a sliding manner with respect to the cartridge door 310 without making the pressing spring 342a compressed. Then, when the closing operation is further executed, the pressing member 340a of the relay member 327a is in contact with the pressed portion 351a while the pressing member 341a of the relay member 327a is in contact with the pressed face 133a of the cartridge 101 (see FIG. 15). By further executing the closing operation of the cartridge door 310 in the above state, the cartridge door 310 is eventually moved to the closing position while making the pressing spring 342a of the relay member 327a compressed (see FIG. 16).

As illustrated in FIG. 13, a distance L3 between the pressing members 340a and 341a of the relay member 327a is longer than a distance L4 between the pressed face 133a of the cartridge 101 and the pressed portion 351a. Because the pressing member 340a is arranged on one end of the pressing spring 342a whereas the pressing member 341a is arranged on another end thereof, the pressing spring 342a applies the urging force of the same intensity to each of the pressing members 340a and 341a. Therefore, similar to the first exemplary embodiment, the cartridge 101 can be urged while a position thereof is stably retained.

<Detachment of Cartridge from Image Forming Apparatus>

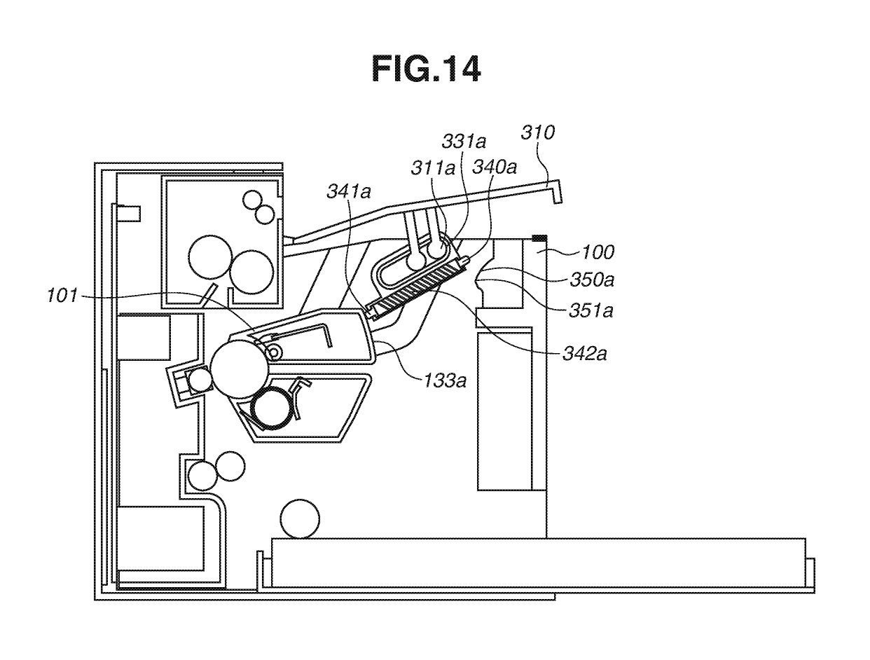

A configuration for taking out the cartridge 101 from the apparatus main body A will be described. An operation opposite to the above-described operation of inserting the cartridge 101 will be executed as an operation of taking out the cartridge 101 from the apparatus main body A. In other words, an opening operation of the cartridge door 310 is executed in a state where the cartridge 101 is located at an image forming position, and the relay member 327a is in contact with both of the cartridge 101 and the pressed portion 351a as illustrated in FIG. 16. When the opening operation of the cartridge door 310 is executed, the relay member 327a is separated from the pressed portion 351a (see FIG. 14). Then, the relay member 327a is separated from the cartridge 101, so that the supporting portion 311a is brought into contact with the regulation face 131a of the elongate hole 360a. Then, when the cartridge door 310 is located at the opening position, the relay member 327a is moved to a position outside the insertion/removal track of the cartridge 101 as illustrated in FIG. 13.

Therefore, the cartridge 101 can be taken out from the inner portion of the apparatus main body A without being in contact with the relay member 327a that presses and holds the cartridge 101. Specifically, in the present exemplary embodiment, the relay member 327a is inserted in a direction intersecting with the pressing direction of the cartridge 101. Therefore, although the cartridge 101 is urged by the pressing spring 342a elastically deformed by the closing operation of the cartridge door 310, a strength necessary for the replacement work of the cartridge 101 can be reduced.

In the variation example, the two supporting portions 311a and 312a are located inside the elongate hole 360a, and the relay member 327a can move in a sliding manner by a predetermined width with respect to the cartridge door 310. However, a configuration in which the relay member 327a does not move rotationally with respect to the cartridge door 310 is not limited to the above. For example, one supporting portion formed into a substantially rectangular shape may be arranged inside the elongate hole 360a, so that the relay member 327a may slide with respect to the cartridge door 310 without moving rotationally.

Further, unlike the first exemplary embodiment, in the present exemplary embodiment, the pressing spring 342a is arranged on the relay member 327a, and the urging unit of the cartridge 101 is not arranged on the apparatus main body A. Therefore, the pressing spring 124a and the pressing lever 125a arranged in the first exemplary embodiment do not have to be arranged thereon, so that a space used for insertion or removal of the cartridge can be increased. Furthermore, the main body can be miniaturized by eliminating the space.

Similar to the second exemplary embodiment, in the present exemplary embodiment, the relay member 327a moves in a sliding manner with respect to the cartridge door 310. However, the configuration is not limited thereto, and similar to the first exemplary embodiment, the relay member 327a may be rotationally moved with respect to the cartridge door 310. Hence, various changes are possible within a scope of the present invention.

In the above-described exemplary embodiment, the relay member is held by the cartridge door, and even in a state where the cartridge is to be pressed, the relay member is in contact with the cartridge door. However, the configuration is not limited to the above. When the cartridge door is opened or closed, the relay member may be held by the cartridge door. Then, when the cartridge is to be pressed, the relay member may be positioned on the cartridge or the apparatus main body without being in contact with the cartridge door. As a fourth exemplary embodiment, a configuration in which a relay member is positioned on the cartridge or the apparatus main body A when the cartridge is pressed will be described. In addition, a reference numeral that is the same as the reference numeral in the first exemplary embodiment is applied to a configuration similar to that of the first exemplary embodiment, and description thereof will be omitted. Further, only a configuration of the drive side will be described. However, a configuration and an operation of the non-drive side are similar to those of the drive side unless otherwise specifically described.

### <Configuration for Pressing Cartridge>

Similar to the first exemplary embodiment, a cartridge door 410 is held by a shaft bearing of the apparatus main body A in a rotationally movable state, and a relay member 427a is arranged on a face of the cartridge door 410 which faces a space inside the apparatus main body A where the cartridge 401 enters. More specifically, supporting portions 411a and 412a are arranged on a face of the cartridge door 410 which faces a space inside the apparatus main body A where the cartridge 401 enters. Then, the relay member 427a includes an elongate hole 430a, and the supporting portions 411a and 412a are arranged to engage with an internal portion of the elongate hole 430a. With this configuration, the relay member 427a can move in a sliding manner with respect to the supporting portions 411a and 412a as well as the cartridge door 410. In the present exemplary embodiment, the relay member 427a includes a pressing spring 424a serving as an elastic member, and a pressing member 440a is arranged on one end of the pressing spring 424a, whereas the relay member 427a is arranged on another end thereof. With this configuration, the pressing spring 424a of the relay member 427a applies a certain spring pressure in a direction in which the pressing member 440a and the relay member 427a are separated from each other. Further, the pressing member 440a is held by the retaining portion 470a while being held by the relay member 427a in a rotationally movable state. Therefore, the pressing member 440a is prevented from coming off or being rotated.

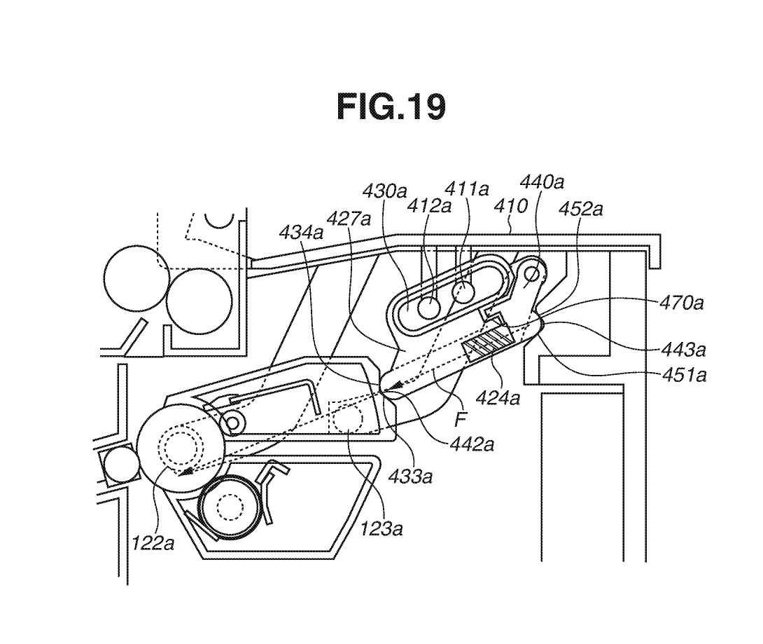

In the present exemplary embodiment, as illustrated in FIG. 19, a pressing face 442a of the relay member 427a and a pressing face 443a of the pressing member 440a are formed into arc-like shapes. Then, a contact face 433a and a retracting face 434a of the cartridge 401, which are in contact with the pressing face 442a of the relay member 427a, constitute a V-shape positioning portion. Further, a contact face 451a and a retracting face 452a of the apparatus main body A, which are in contact with the pressing face 443a of the pressing member 440a, constitute a V-shape positioning portion. Then, because the pressing spring 424a applies spring pressure in a direction in which the pressing member 440a and the relay member 427a are separated from each other, the pressing face 442a of the relay member 427a and the pressing face 443a of the pressing member 440a which are formed into arc-like shapes respectively are positioned at the V-shape consisting of the contact face 433a and the retracting face 434a of the cartridge 401 and the V-shape consisting of the contact face 451a and the retracting face 452a of the apparatus main body A. Therefore, a vector F of the pressing force which is generated by the pressing spring 424a and applied to the cartridge 401 extends along a straight line that connects an arc center of the pressing face 442a of the relay member 427a and an arc center of the pressing face 443a of the pressing member 440a.

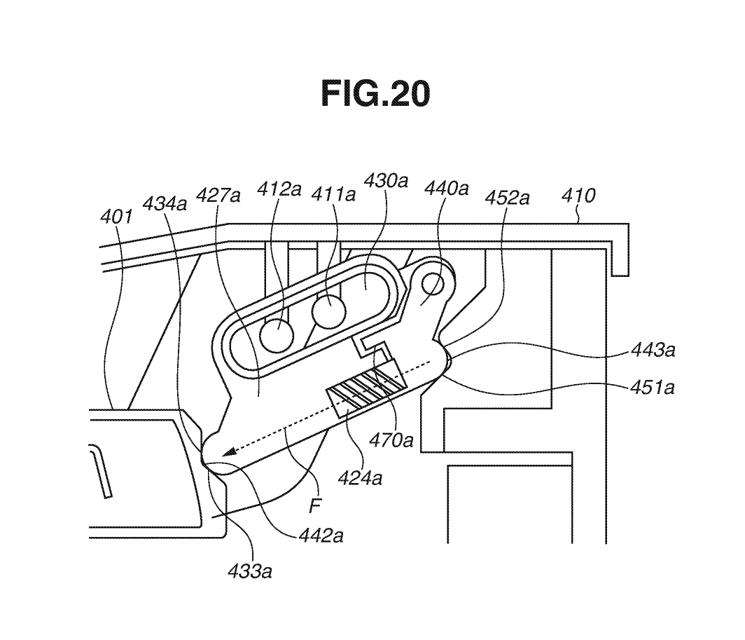

As illustrated in FIG. 20, the vector F of the pressing force applied to the cartridge 401 extends along a straight line similar to a bisector of the V-shape consisting of the contact face 433a of the cartridge 401 and the retracting face 434a, and the straight line extends in a space between the positioning portion 122a and the rotation stopper portion 123a of the cartridge 401. Therefore, in the present exemplary embodiment, because both of the positioning portion 122a and the rotation stopper portion 123a of the cartridge 401 are thereby urged, the cartridge 401 can be more stably held. In a case where own weight or driving moment of the cartridge 401 is taken into consideration, similar to the first exemplary embodiment, the vector F of the pressing force applied to the cartridge 401 may pass through the rotation center of the photosensitive drum 102.

As described above, when the cartridge 401 is to be pressed, the relay member 427a and the pressing member 440a respectively are positioned by the cartridge 401 and the apparatus main body A. Therefore, the elongate hold 430a of the relay member 427a is arranged to have a gap between the supporting portions 411a and 412a, and the relay member 427a is not in contact with the cartridge door 410 when the cartridge door 410 is closed. Thus, the pressing force can be stably applied to the cartridge 401 without being influenced by the position of the cartridge door 401.

### <Attachment of Cartridge to Image Forming Apparatus>

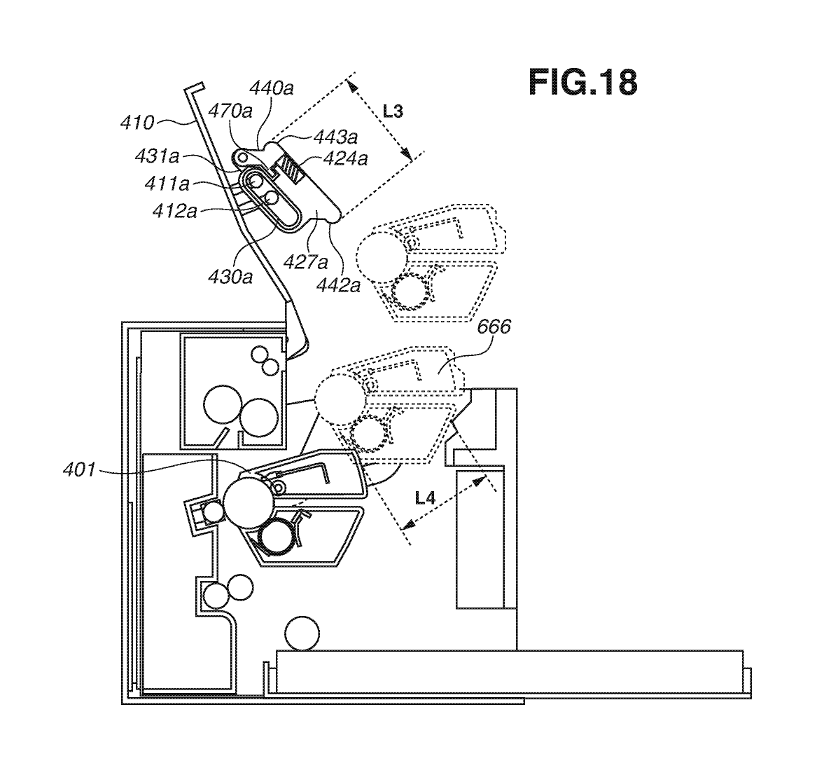

Next, with reference to FIG. 18 and FIGS. 21 to 23, an operation of urging and inserting the cartridge 401 to the image forming position by the relay member 427a after the user opens the cartridge door 410 to insert the cartridge 401 from the formed opening portion 666 will be sequentially described.

The user opens the cartridge door 410 and inserts the cartridge 401 to make the positioning portion 122a and the rotation stopper portion 123a of the cartridge 401 respectively held by the guides 114a and 115a of the apparatus main body A. An orientation of the cartridge 401 is determined when the cartridge 401 is held by the two guides 114a and 115a, and the cartridge 401 is moved according to the shapes of the guides 114a and 115a. Accordingly, the cartridge 401 is moved while following an insertion/removal track of the cartridge 401 as illustrated in FIG. 18. When the cartridge door 410 is opened, the relay member 427a is held at a position outside the insertion/removal track of the cartridge 401 in an orientation in which the supporting portion 411a is in contact with the regulation face 431a of the elongate hole 430a because of the gravitational force.

As a result, insertion or removal of the cartridge 401 will not be interrupted because the relay member 427a is located at a position outside the insertion/removal track of the cartridge 401. Accordingly, when the cartridge 401 is to be inserted, the cartridge 401 can be inserted to the apparatus main body A without being in contact with the relay member 427a.

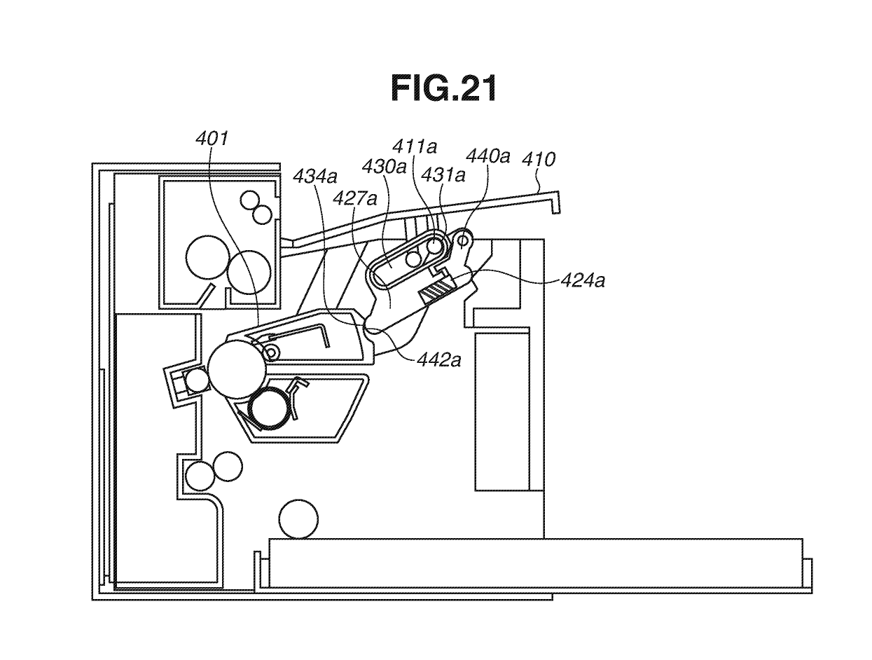

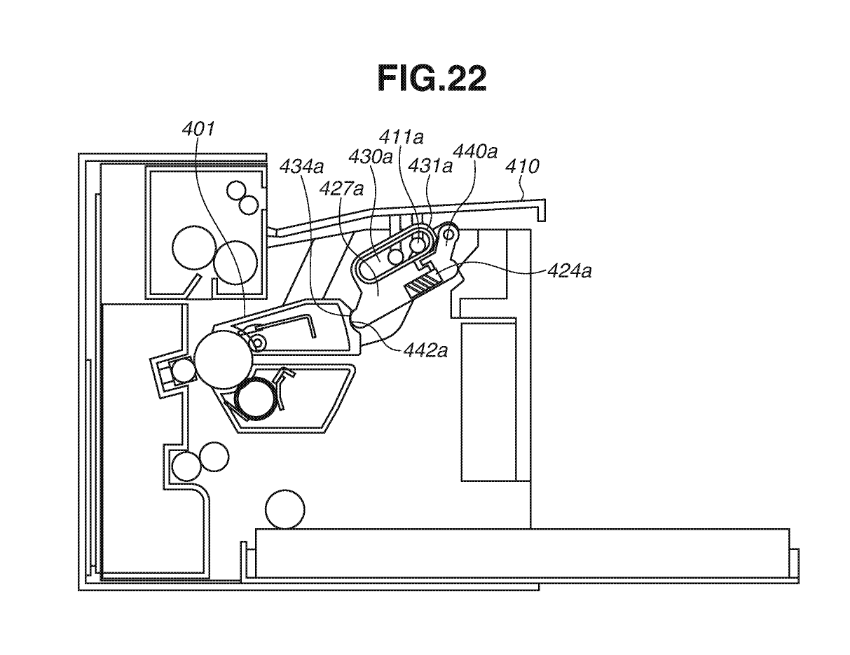

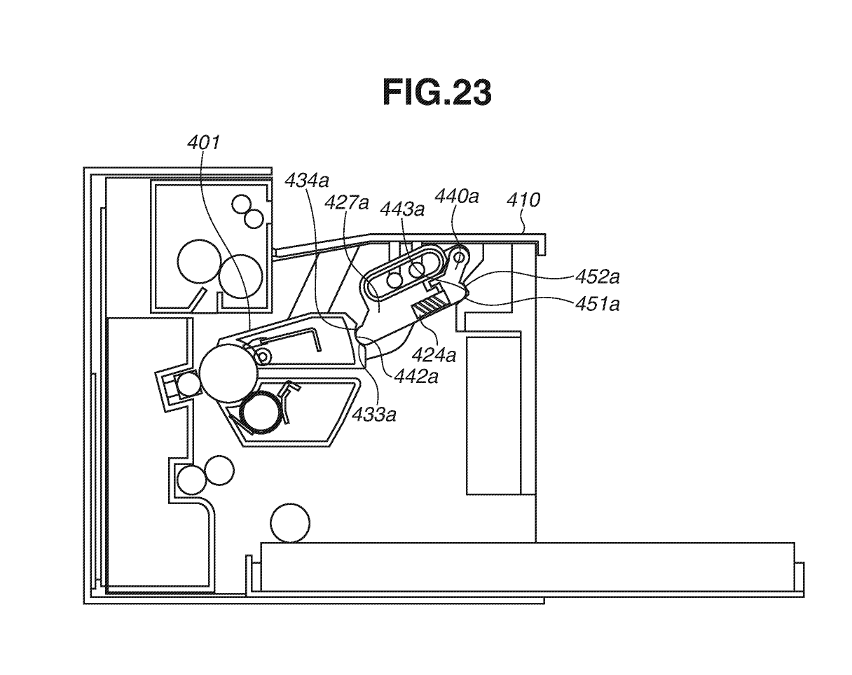

As illustrated in FIG. 18, when the user inserts the cartridge 401 to the apparatus main body A and executes a closing operation of the cartridge door 410 to move the cartridge door 410 from the opening position to the closing position, the pressing face 442a of the relay member 427a is in contact with the retracting face 434a of the cartridge 401 (see FIG. 21). When the closing operation of the cartridge door 410 is further executed, the relay member 427a starts moving in a sliding manner with respect to the cartridge door 410, and the supporting portion 411a is separated from the regulation face 431a of the elongate hole 430a. At this time, the relay member 427a moves in a sliding manner with respect to the cartridge door 410 without making the pressing spring 424a compressed (see FIG. 22). Then, when the closing operation is further executed, the pressing face 443a of the pressing member 440a of the relay member 427a is in contact with the apparatus main body A while the pressing member 440a of the relay member 427a is in contact with the retracting face 434a of the cartridge 401. By further executing the closing operation of the cartridge door 410 in the above state, the retracting face 452a of the apparatus main body A causes the pressing face 443a of the pressing member 440a to compress the pressing spring 424a of the relay member 427a, so that the relay member 427a and the pressing member 440a are retracted to determined positions. The cartridge door 410 is eventually moved to the closing position (see FIG. 23).

As illustrated in FIG. 18, a distance L3 between the pressing face 442a of the relay member 427a and the pressing face 443a of the pressing member 440a is longer than a distance L4 between the V-shape consisting of the contact face 433a and the retracting face 434a of the cartridge 401 and the V-shape consisting of the contact face 451a and the retracting face 452a of the apparatus main body A. Because the pressing member 440a is arranged on one end of the pressing spring 424a whereas the relay member 427a is arranged on another end thereof, the pressing spring 424a applies the urging force of the same intensity to each of the pressing member 440a and the relay member 427a.

Therefore, similar to the first exemplary embodiment, the cartridge 401 can be urged while a position thereof is stably retained. Further, because the supporting portions 411a and 412a of the cartridge door 410 are not in contact with the elongate hole 430a of the relay member 427a, the cartridge 401 can be more stably urged and held without being influenced by the cartridge door 410. Furthermore, because the relay member 427a and the pressing member 440a are retracted to the positioned place together with the cartridge door 410, the relay member 427a and the pressing member 440a including the cartridge door 410 can be suppressed from being stopped halfway.

<Detachment of Cartridge from Image Forming Apparatus>

A configuration for taking out the cartridge 401 from the apparatus main body A will be described. An operation opposite to the above-described operation of inserting the cartridge 401 will be executed as an operation of taking out the cartridge 401 from the apparatus main body A. In other words, an opening operation of the cartridge door 410 is executed in a state where the cartridge 401 is located at the image forming position, and the relay member 427a is in contact with the cartridge 401, whereas the pressing member 440a is in contact with the apparatus main body A as illustrated in FIG. 23. When the opening operation of the cartridge door 410 is executed, the pressing member 440a is separated from the retracting face 452a (see FIG. 22). Then, the relay member 427a is separated from the cartridge 401, so that the supporting portion 411a is eventually brought into contact with the regulation face 431a of the elongate hole 430a (see FIG. 21). When the cartridge door 410 is located at the opening position, the relay member 427a is moved to a position outside the insertion/removal track of the cartridge 401 as illustrated in FIG. 18.

Therefore, the cartridge 401 can be taken out from the inner portion of the apparatus main body A without being in contact with the relay member 427a that presses and holds the cartridge 401. Specifically, in the present exemplary embodiment, the relay member 427a is inserted in a direction intersecting with the pressing direction of the cartridge 401. Because the pressing spring 424a is elastically deformed by a requisite minimum amount through the closing operation of the cartridge door 410, a strength necessary for the replacement work of the cartridge 401 can be reduced even if the cartridge 401 is urged.

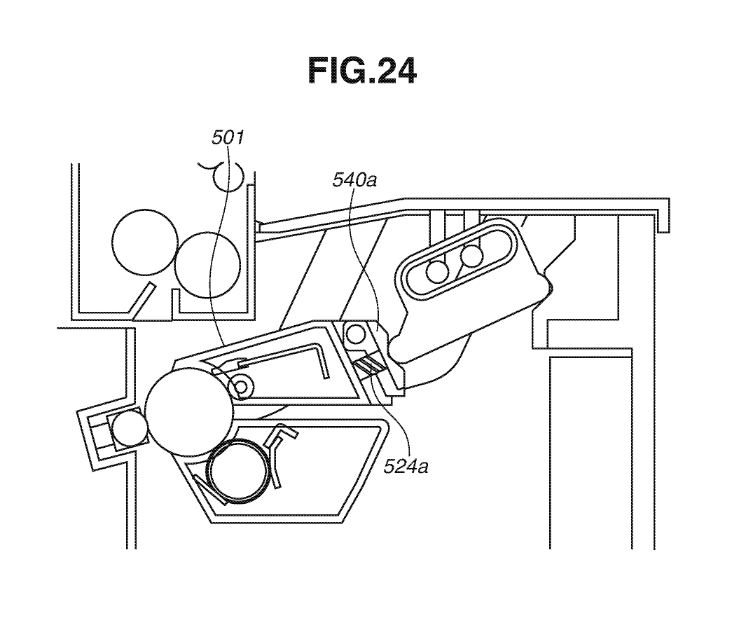

In the variation example, the pressing spring 424a is arranged on the relay member 427a, and the urging unit of the cartridge 101 is not arranged on the apparatus main body A. However, as illustrated in FIG. 24, a pressing member 540a and a pressing spring 524a may be arranged on a cartridge 501. With this configuration, a pressing force applied to the cartridge 501 can be generated by the pressing spring 524a arranged on the cartridge 501, so that the pressing force can be changed by the cartridge 501.

In the variation example, the two supporting portions 4111a and 412a are located inside the elongate hole 430a, and the relay member 427a can move in a sliding manner by a predetermined width with respect to the cartridge door 410. However, a configuration in which the relay member 427a does not move rotationally with respect to the cartridge door 410 is not limited to the above. For example, one supporting portion formed into a substantially rectangular shape may be arranged inside the elongate hole 430a, so that the relay member 427a may slide with respect to the cartridge door 410 without moving rotationally.

Furthermore, different from the first exemplary embodiment, in the present exemplary embodiment, the pressing spring 424a is arranged on the relay member 427a, and the urging unit of the cartridge 401 is not arranged on the apparatus main body A. Therefore, the pressing spring 124a and the pressing lever 125a arranged in the first exemplary embodiment do not have to be arranged thereon, so that a space used for insertion or removal of the cartridge 401 can be increased. Further, the main body can be miniaturized by eliminating the space.

Further, similar to the second exemplary embodiment, in the present exemplary embodiment, the relay member 427a moves in a sliding manner with respect to the cartridge door 410. However, the configuration is not limited thereto. Similar to the first exemplary embodiment, the relay member 427a may be rotationally moved with respect to the cartridge door 410. Therefore, various changes are possible within a scope of the present invention.

In a configuration described in a fifth exemplary embodiment, a relay member 650 is arranged on a portion of the apparatus main body A that is immovable together with the cartridge door 110. The other configurations are similar to those described in the first exemplary embodiment.

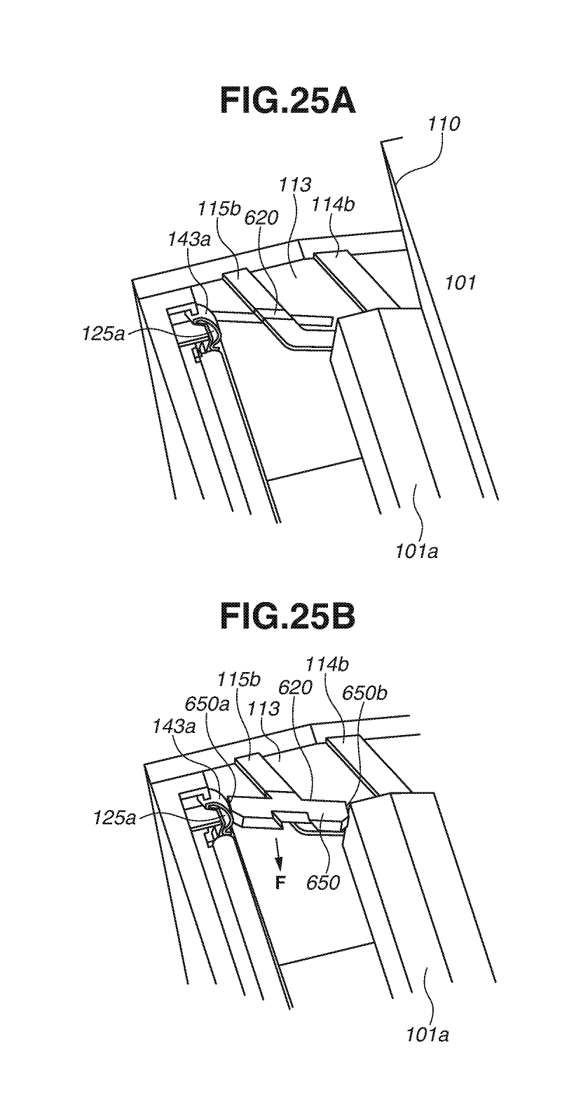

FIG. 25A is a perspective diagram of a part of an inner portion of the apparatus main body A on a side of the side plate 113, illustrating a state where the cartridge 101 (drum unit 101a) is attached, and the cartridge door 110 is opened. A slit 620 is arranged in the side plate 113 on which the guides 114b and 115b are arranged. The relay member 650 (not illustrated) is arranged on the outside of the slit 620. Further, in FIG. 25A, a pressing face 143a of the pressing lever 125a and the drum unit 101a have nothing in between. In other words, the relay member 650 is located at a position (second position) at which the relay member 650 is not held between the pressing face 143a of the pressing lever 125a and the drum unit 101a. On the other hand, FIG. 25B is a perspective diagram of a part of the inner portion of the apparatus main body A on a side of the side plate 113, illustrating a state where the cartridge 101 is attached, and the cartridge door 110 (not illustrated) is closed. The relay member 650 is projected to the inner side of the apparatus main body A in a direction indicated by an arrow F from the slit 620 of the side plate 113. Then, one end 650a of the relay member 650 is in contact with the pressing face 143a of the pressing lever 125a, whereas another end 650b of the relay member 650 is in contact with the pressed face 133a of the drum unit 101a. In other words, the relay member 650 is located at a position (first position) at which the relay member 650 is held between the pressing face 143a of the pressing lever 125a and the pressed face 133a of the drum unit 101a. Similar to the first exemplary embodiment, at the first position, the relay member 650 urges the cartridge 101 to make the cartridge 101 abut on the abutting portion 120a of the apparatus main body A, so that the position with respect to the apparatus main body A is determined. The relay member 650 can be moved between the first position and the second position in conjunction with the movement of the cartridge door 110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-193781, filed Oct. 3, 2017, which is hereby incorporated by reference herein in its entirety.

What is claimed is:

1. An image forming apparatus comprising:
a first unit including an image bearing member capable of rotating while bearing a toner image;
a second unit including a development member which supplies toner to the image bearing member to develop the toner image;
an apparatus main body to which the first unit is detachably attached in a direction intersecting with a rotation axis of the image bearing member, the apparatus main body including an opening portion through which the first unit passes when the first unit is to be attached to or detached from the apparatus main body, an opening-closing member which can be moved to open or close the opening portion, a first portion which is in contact with a part of the first unit to position the first unit with respect to the apparatus main body, and a second portion, which does not move together with the opening-closing member, arranged on an opposite side of the first portion with respect to the image bearing member in the intersecting direction; and
a sandwiched unit configured to be movable between a first position at which the sandwiched unit is sandwiched between the first unit and the second portion to press the first unit against the first portion and a second position at which the sandwiched unit is not sandwiched between the first unit and the second portion,
wherein, when the sandwiched unit is located at the first position, a part of the first unit is urged and brought into contact with the first portion by the sandwiched unit.

2. The image forming apparatus according to claim 1,
wherein the sandwiched unit is connected to the opening-closing member, and
wherein the sandwiched unit is located at the first position when the opening-closing member is closed, and located at the second position when the opening-closing member is opened.

3. The image forming apparatus according to claim 2, wherein the sandwiched unit is movably connected to the opening-closing member.

4. The image forming apparatus according to claim 3, wherein the sandwiched unit is not in contact with the opening-closing member when the sandwiched unit is located at the first position.

5. The image forming apparatus according to claim 3, wherein the sandwiched unit has a regulation portion which regulates a movable range with respect to the opening-closing member.

6. The image forming apparatus according to claim 1, wherein the second unit is detachably attached to the apparatus main body together with the first unit.

7. The image forming apparatus according to claim 1,
wherein the second portion includes an elastic member, and
wherein the first unit is in contact with the first portion by receiving an elastic force of the elastic member through the sandwiched unit.

8. A cartridge detachably attached to an apparatus main body of an image forming apparatus including an opening portion through which the cartridge passes when the cartridge is to be attached to the apparatus main body, an opening-closing member which can be moved to open or close the opening portion, a first portion which positions the cartridge with respect to the apparatus main body, and a second portion which does not move together with the opening-closing member, and a sandwiched unit which is sandwiched between the cartridge and the second portion, the cartridge comprising:
an image bearing member configured to bear a toner image; and
a frame supporting the image bearing member so that the image bearing member is rotatable,
wherein the frame member includes a sandwiching portion formed into a concave shape which sandwiches the sandwiched unit with the second portion in a case where the cartridge is attached to the apparatus main body.

9. The cartridge according to claim 8, wherein the sandwiching portion is formed into a V-shape.

10. The cartridge according to claim 9, in a case where the frame is a first frame, the cartridge further comprising:
a development roller which supplies toner to the image bearing member to develop the toner image; and
a second frame which supports the development roller so that the image bearing member is rotatable,
wherein the sandwiching portion is arranged on the first frame.

11. The cartridge according to claim 10, wherein the pinch portion is formed into a V-shape.
